(19) United States
(12) Patent Application Publication
(10) Pub. No.: US 2018/0257051 A1
(43) Pub. Date: Sep. 13, 2018

(54) METHOD AND DEVICE FOR MAKING UP A PHARMACEUTICAL PREPARATION

(71) Applicants: MEDICAL DISPENSING SYSTEMS, Enschede (NL); Fresenius Kabi Deutschland GmbH, Bad Homburg (DE)

(72) Inventors: Heffney De Haan, BD Enschede (NL); Richard Smith, Mainz (DE); Sander Van Vreeland, BR Enschede (NL); Kees Rinzema, MG Enscheide (NL); Henrik Schaake, Bad Homburg (DE)

(21) Appl. No.: 15/762,167

(22) PCT Filed: Sep. 21, 2016
(86) PCT No.: PCT/EP2016/072433

§ 371 Date: Mar. 22, 2018

(30) Foreign Application Priority Data
Sep. 22, 2015 (EP) 15186273.7

(51) Int. Cl. B01F 13/10; B01F 15/02

(52) U.S. Cl. CPC B01F 13/1061; B01F 2215/0034; B01F 2215/0032; B01F 15/0237

(57) ABSTRACT

A device for making up a pharmaceutical preparation comprising at least one first mounting device adapted to hold a source container filled with a liquid component of the pharmaceutical preparation, at least one second mounting device adapted to hold a target container provided with at least one access port for receiving the liquid component of the pharmaceutical preparation, and at least one third mounting device adapted to hold a transfer container adapted to transfer the liquid component from the source container to the target container. The at least one third mounting device is movable with respect to the at least one first mounting device and to the at least one second mounting device such that the liquid component can be transferred from the source container to the target container.

The invention relates to a device for making up a pharmaceutical preparation and to a method for making up a pharmaceutical preparation according to the independent claims.

Generally a device or method for making up a pharmaceutical preparation is employed for example for preparing a liquid pharmaceutical preparation composed of several (liquid) components on the basis of a prescription. It allows to vary the chemical composition of the pharmaceutical preparation and to adjust a concentration of a pharmaceutic agent (drug) in the pharmaceutical preparation. For example, a liquid drug as one liquid component is added to a carrier solution as another liquid component. In this example, the liquid drug has a specific pharmaceutical effect, while the carrier solution basically serves to adjust a specific concentration of the liquid drug in the pharmaceutical preparation. The thus obtained liquid pharmaceutical preparation may serve for intravenous administration. Said device and method are typically employed for making up patient specific preparations of cytotoxic agents in the context of a chemotherapy for cancer.

In this context it is of great importance that the pharmaceutical preparation corresponds precisely to the prescription. It is therefore important that the dosing ratios are correctly realized. Furthermore it is very important that the correct liquid components are used to compose the pharmaceutical preparation.

It is an object of the present invention to provide a method and device for making up a pharmaceutical preparation that allow for a precise dosing of the liquid components and a reliable handling of different liquid components.

This object is achieved by the device for making up a pharmaceutical preparation comprising the features of claim 1.

Accordingly, the device for making up a pharmaceutical preparation comprises at least one first mounting device adapted to hold a source container filled with a liquid component of the pharmaceutical preparation, at least one second mounting device adapted to hold a target container provided with at least one access port for receiving the liquid component, and at least one third mounting device adapted to hold a transfer container adapted to transfer the liquid component from the source container to the target container.

The number of the first, second and third mounting devices may be variable and adapted to the needs of a user. In particular the number of first mounting devices may depend on the number of different liquid components required to make up the pharmaceutical preparation. The at least one first mounting device and the at least one second mounting device may be removably attached to a mounting structure of the device for making up a pharmaceutical preparation, wherein the first and second mounting devices may be arranged in predefined positions within the mounting structure. The mounting structure may have the form of a rack.

The number of third mounting devices may correspond to the number of required transfer containers. In general, for each liquid component to be transferred from the source container to a target container a separate transfer container is or can be used. The number of third mounting devices may therefore depend on the number of different liquid components required to make up the pharmaceutical preparation. According to an alternative, only one third mounting device is provided that is configured to pick up the transfer containers one by one from a storage device, storing a plurality of transfer containers.

In order to transfer the liquid component from the source container to the target container the at least one third mounting device is movable with respect to the at least one first mounting device and to the at least one second mounting device. The movement of the at least one third mounting device may be achieved by a motor that is controlled by a processor.

Furthermore an actuator may be provided that acts on the transfer container to make the liquid component, in particular a predefined amount of the liquid component, flow out of the source container into the transfer container and to make the liquid component flow out of the transfer container into the target container. This actuator may also be controlled by the processor that is controlling the motor.

All kind of source containers, preferably made of glass or plastic, could be used including plastic or glass bottles. Preferably the source container may be a glass or plastic vial or a plastic bag. The source container may be filled with different, well defined, preferably regarding composition and concentration, liquid components, such as a carrier solution or a liquid drug. The transfer container may be a syringe with a tube and a plunger movable inside the tube. The tube may be attached to a needle with a needle tip. The above mentioned actuator may act on the plunger of the syringe in order to move the plunger out of/into the tube.

The target container may be an intravenous bag, a syringe or an elastomeric pump or a squeezable pouch. According to one embodiment of the invention the at least one second mounting device comprises an adapter to hold the target container. The adapter is not only adapted to hold an intravenous bag, but in particular also adapted to hold a syringe or an elastomeric pump or a squeezable pouch as the target container. This gives the user a choice of the type of target container to use and increases the flexibility for the user of the device for making up a pharmaceutical preparation. Instead of providing the pharmaceutical preparation first in an intravenous bag and if necessary transferring the pharmaceutical preparation into a syringe or elastomeric pump, the pharmaceutical preparation is directly prepared in the target container that will be used for administration of the pharmaceutical preparation to a patient. An additional step of transferring the pharmaceutical preparation is not required.

The adapter of the at least one second mounting device may comprise a through hole for loosely receiving the access port of the syringe or elastomeric pump (target container). In order to fix the target container to the adapter, the adapter may comprise a bracket movable between a locking position, wherein the target container is securely fixed to the adapter, and a release position, wherein the target container is separable from the adapter. The bracket may be rotatable about a swivel axis. Furthermore, the bracket may comprise a recess for receiving and securely holding the access port of the target container. Preferably the access port is hold in the recess of the bracket by non-positive (force fitting) and/or positive (form fitting) locking. For instance, the bracket may be made of a metal. As the access port is usually of a plastic material, which is more ductile than the metal bracket, the access port material may be slightly compressed by the metal bracket in the locking position. The frictional force resulting from the compression may contribute to securely hold the access port in the recess of the bracket.

The source container may comprise an access port with a septum that is puncturable by the needle of the syringe that forms the transfer container. Also the access port of the syringe or elastomeric pump or bag as the target container may be or are provided with an injection port with a septum that is puncturable in order to inject the liquid component into the syringe or elastomeric pump or bag (target container) from the syringe (transfer container). In case of the syringe or elastomeric pump the injection port may be removably attached to the access port of the syringe or elastomeric pump (target container) during a production run. Afterwards the injection port may be removed from the target container and replaced, so that for instance the original access port of the syringe or elastomeric pump (target container) is at the user's disposal for administering the pharmaceutical preparation. The injection port may be attached using a Luer-lock or Luer(-slip) connection, for instance.

According to one embodiment of the invention the at least one third mounting device comprises at least one stop element for limiting a movement of the transfer container in direction to the at least one first mounting device and/or to the at least one second mounting device. This measure allows to adopt reliably a precise, predefined position of the transfer container with respect to the source container and/or target container and allows for a precise transfer procedure. Preferably, the at least one third mounting device comprises at least two stop elements, arranged such as to receive the transfer container in between them and to limit a movement of the transfer container in a direction towards the at least one first mounting device and towards the at least one second mounting device as well as a movement of the transfer container in a direction away from the at least one first mounting device and from the at least one second mounting device.

In case that the transfer container is a syringe, the at least one stop element may be arranged on the third mounting device such that the tube of the syringe does not accidently move with the plunger when the plunger is moved in the tube of the syringe. As the plunger may be moved into the tube (during an injection into the target container) and out of the tube (during a withdrawal from the source container), two step elements may be provided, one which limits the movement of the tube when the plunger is moved into the tube and preferably another one which limits the movement of the tube when the plunger is moved out of the tube.

In case that the transfer container is a syringe, the third mounting device may comprise a first subunit and a second subunit that are movable with respect to each other in order to make the plunger move with respect to the tube. The first subunit may be adapted to hold the plunger of the syringe and the second subunit may be adapted to hold the tube of the syringe. The plunger and the tube may be hold for instance radially by clamping jaws. The relative movement of the subunits may be used to move the plunger inside the tube. Each of the subunits may be provided with one of the stop elements. The stop element of the second subunit that is holding the tube may be arranged such as to limit the movement of the tube in a direction in which the plunger is moved, when the plunger is moved into the tube. The stop element of the first subunit that is holding the plunger may be arranged such as to improve the load transmission along a longitudinal axis of the syringe from the first subunit (that is moving with respect to the second subunit) to the plunger, in particular to the plunger's free axial end, when the plunger is moved into the tube. In an alternative, two stop elements are provided on the second subunit and are arranged such as to block the tube of the syringe in between them along the axis of movement of the plunger, when the plunger is moved into the tube as well as when the plunger is moved out of the tube.

The first subunit may be moved with respect to the second subunit by means of a stepper motor, in particular of the type HECM 246-F1.3. Further stepper motors (of this type) may be provided to move the third mounting device (in its entirety) with respect to the at least one first mounting device and to the at least one second mounting device. For each axis in a 3-dimensional space a separate stepper motor may be provided.

According to another embodiment of the invention a camera may be provided that is adapted to capture an image of the at least one source container and/or of the at least one target container, wherein the image comprises image data representative of the liquid component filled in the source container or the pharmaceutical preparation to be made up in the target container. The image data may comprise an optical pattern like a one-dimensional or a two-dimensional code or a series of alphanumeric characters. The camera may be of the type of a webcam. The camera is used during pre-processing and/or during processing, i.e. during a production run. For image recognition, the camera may be connected to a processor that is adapted to receive the image data from the camera. The processor may be configured to process the image data such as to identify the liquid component filled in the source container and/or the pharmaceutical preparation to be made up in the target container by means of image recognition. Preferably, the processor used for image recognition is furthermore configured to control the motors mentioned above.

The object as mentioned at the beginning is also achieved by the method for making up a pharmaceutical preparation comprising the steps of claim 14.

Accordingly, a source container filled with a liquid component of the pharmaceutical preparation is mounted on a first mounting device, a target container provided with at least one access port for receiving the liquid component of the pharmaceutical preparation is mounted on a second mounting device and a transfer container adapted to transfer the liquid component from the source container to the target container is mounted on a third mounting device. By means of the transfer container the liquid component is then withdrawn from the source container, while the third mounting device is in a withdrawal position. After withdrawal, the liquid component is injected from the transfer container into the target container. For the injection the transfer container is brought into an injection position by moving the third mounting device.

The method may be carried out by using the device mentioned before. Accordingly, even if not explicitly mentioned, the device comprises corresponding means or components for performing the described method step(s).

In some cases the target container is already prefilled with a liquid component, such as a carrier solution, to which another liquid component (a liquid drug) provided in a source container shall be added. If on the other hand the pharmaceutical preparation is made up from several (liquid) components provided in individual source containers, for each liquid component to be transferred from a source container into the target container a separate transfer container is or can be used. The number of third mounting devices may correspond to the number of required transfer containers. According to an alternative, only one third mounting device is provided that is configured to pick up the transfer containers one by one from a storage device, storing a plurality of transfer containers.

In case that not only one, but a plurality of target containers shall be filled with the same liquid component within one production run, for each target container the liquid component may be withdrawn (in the prescribed amount) by the transfer container from the source container and then (completely) injected into one of the target containers. That is, the amount of liquid component withdrawn from the source container corresponds to the amount required for the respective target container. Before injecting the liquid component into another target container, the transfer container is moved back to the source container and another well-defined amount of liquid component is withdrawn from the source container for the next target container. This procedure is repeated for every target container. This procedure may be applied for a production run with a plurality of target containers to be filled with the same pharmaceutical preparation as well as for a production run with a plurality of target containers to be filled with (at least partly) different pharmaceutical preparations. The expression different pharmaceutical preparations shall refer to pharmaceutical preparations with different chemical compositions, different mixing ratios of the individual liquid components, different total volumes and/or different types of target containers.

According to another embodiment of the invention, the method may provide to set a speed for withdrawing the liquid component from the source container and/or for injecting the liquid component into the target container, wherein the speed depends on the nature of the liquid component. For instance, the viscosity of the liquid component may be considered when adjusting said speed. Further characteristics of the liquid component could be taken into account for adjusting the speed. A liquid component with high viscosity may be withdrawn and/or injected with a lower speed than a liquid component with a comparatively low viscosity. This procedure allows to precisely dose the liquid component according to the prescription. The device comprises means for setting the speed for withdrawing or injecting the liquid component.

As already mentioned the method may provide that the transfer container is moved between the source container(s) and the target container(s). The transfer container moves in a three-dimensional space with the orthogonal axes X, Y and Z. For withdrawing the liquid component from the source container and for injecting the liquid component into the target container the transfer container needs to adopt a well-defined withdrawal position with respect to the source container and a well-defined injection position with respect to the target container, respectively. That means that the third mounting device is moved between a defined withdrawal position with respect to the first mounting device and a defined injection position with respect to the second mounting device. In particular in case that the transfer container is a syringe with a needle extending along the Z-axis, the method may provide that the third mounting device is moved along the X- and Y-axes (each extending orthogonally to the Z-axis) only as long as a distance between the third mounting device and the first or second mounting device along the Z-axis does not fall below a predefined threshold value. Once the third mounting device is aligned along the X- and Y-axes according to the withdrawal position/injection position, the third mounting device may move along the Z-axis and reduce its distance to the first/second mounting device until the withdrawal position/injection position is reached. This measure helps to avoid undesirable collisions between the transfer container and the source containers and/or target containers.

According to another embodiment of the invention, the withdrawal position, that is defined by the relative position of the third mounting device and the first mounting device, is dependent on the type, shape and/or size of the source container. If the transfer container is a syringe with a needle for instance, the withdrawal position may define an insertion depth of the needle of the syringe into the source container in dependence of the type, shape and/or size of the source container. Such a source container dependent withdrawal position allows for an optimal emptying of the different source containers and for reducing waste resulting from residual liquid components. The withdrawal position may further depend on the transfer container, in particular on the type, shape and/or size of the transfer container. When the withdrawal position is reached, the liquid component may be withdrawn from the source container.

In case that the transfer container is a syringe comprising a needle with a needle tip and the source container comprises an injection port which is puncturable by the needle, the step of withdrawing the liquid component from the source container may comprise puncturing the injection port of the source container with the needle tip of the syringe and moving the third mounting device in the predefined, source container dependent withdrawal position. In this withdrawal position the needle tip reaches through the injection port into the source container by a predefined amount. The extent by which the needle reaches into the source container may depend on the type of the source container.

According to another embodiment of the invention, the method may provide that before withdrawing the liquid component from the source container, the transfer container may suck in a predefined volume of air. This measure allows to precisely dose the liquid component according to the prescription.

In case that the transfer container is a syringe comprising a needle with a needle tip and the source container comprises an injection port, a predefined volume of air may be sucked into the syringe before puncturing the injection port of the source container with the needle tip. The air may be sucked by moving the plunger of the syringe out of the tube over a predefined distance, i.e. by moving the first subunit of the third mounting device with respect to the second subunit of the third mounting device. The predefined distance may depend on the syringe's volume and/or diameter. As the plunger has a certain level of flexibility, the movement of the plunger for sucking the air into the tube may deform the plunger, which allows for a higher dosing accuracy as the deformation does not occur during the withdrawal of the liquid component from the source container but before. After the predefined amount of air has been sucked into the syringe the syringe may be moved into the withdrawal position.

In order to realize this procedure the device may comprise a processor configured to control a motor, which is adapted to move the first subunit with respect to the second subunit of the third mounting device, and another motor, which is adapted to move the entire third mounting device with respect to the first mounting device, such that the interplay of the two motors allows to suck air into the syringe before withdrawing the liquid component from the source container.

In case that the transfer container is a syringe comprising a needle with a needle tip and the source container comprises an injection port which is puncturable by the needle following contamination prevention measure may be provided. In order to prevent contamination (of the device) with one of the liquid components that may stick on the outside of the needle tip of the syringe as the transfer container after withdrawing the liquid component from the source container, the syringe may be moved into a contamination prevention position before pulling the needle tip of the syringe out of the source container. The contamination prevention position may be a position in which the needle tip is placed within the septum of the injection port of the source container. That is a position in which the needle is neither in contact with the liquid component filled in the source container nor with the atmosphere surrounding the source container. The contamination prevention position, in particular the precise position of the needle tip within the septum, may be dependent on the source container. For instance the contamination prevention position may depend on the volume of the source container and the thickness and/or material of the septum. Additionally the contamination prevention position may depend on the transfer container, in particular on the type, shape and/or size of the transfer container. Once the third mounting device has been moved such that the needle tip is in the contamination prevention position, the plunger is slightly pulled out of the syringe tube in order to create an underpressure in the syringe. Hereby droplets of the liquid component present at the outside of the needle tip are sucked into the transfer container. While maintaining the underpressure in the syringe, the needle with the needle tip free from the liquid component may completely be pulled out of the septum of the source container.

In order to realize this procedure a processor may be configured to control the motor, which is adapted to move the first subunit with respect to the second subunit of the third mounting device, and the motor, which is adapted to move the entire third mounting device with respect to the first mounting device, such that the interplay of the two motors allows to create an underpressure in the syringe in the contamination prevention position and to maintain the underpressure while pulling the needle of the syringe out of the source container.

The same procedure may be applied analogously before pulling the needle tip of the syringe out of the target container that is sealed by a septum in order to avoid contamination (of the device) with a mixture of liquid components or the pharmaceutical preparation present in the target container. In this case the contamination prevention position (the position of the needle tip within the septum) is in particular dependent on the type of the target container and may additionally be dependent on the type of the transfer container. The processor may be configured to control the motors accordingly.

According to another embodiment of the invention, the method may provide that the status of each source container and each target container is tracked throughout the entire production run. The status may be updated whenever a step of the production run is started and/or finished. An update may be provided in particular at the beginning of a withdrawal step, at the end of a withdrawal step, at the beginning of an injection step and at the end of an injection step. The registration of the status of the source containers and in particular of the target containers is of advantage in case of a failure of the device for making up a pharmaceutical preparation. If the device stops and a production run is aborted because of the failure, the status of all the containers is known at the moment of abortion by means of status tracking. The target containers that are filled with the final pharmaceutical preparation at the moment of abortion may be released for use. Other target containers that are filled with part of the liquid components required to form the pharmaceutical preparation may be introduced into another production run for completing the pharmaceutical preparation or discarded. As their status has been tracked throughout the entire production run that has been aborted, the user may unambiguously determine the liquid components that are present in the target container. If the abortion does not arise during an injection step also the respective quantity of each liquid component in the target containers may be determined. These target containers may be further processed in order to finish the pharmaceutical preparation in another production run. If the abortion arises during an injection step, it may be difficult to determine exactly the amount of the liquid component that has been injected into the target container during this injection step. The target container concerned may be discarded. The tracking thus allows to distinguish the status of the different target containers if the production run is aborted. It is not necessary to discard all target containers of the production run concerned. This measure helps to reduce waste and provides a continuous quality control of the production run.

In order to track the status of the source containers and target containers these containers may be provided with an identification means. The identification means for instance may be an RFID (radio-frequency identification) tag. Preferably the identification means is attached to the containers indirectly. For instance, the identification means may be integrated with or attached to the first and second mounting devices. By mounting the source containers and the target containers to respective first and second mounting devices, the source containers and the target containers are provided each with an individual identification means. Further labels as identification means could be used.

The RFID tag may be scanned regularly in order to track the status of each source container and each target container, in particular the beginning of a withdrawal step, the end of a withdrawal step, the beginning of an injection step and the end of an injection step.

In case of an error related to the scanning of the identification means, the method may provide the possibility to a user to choose between several options, such as scanning again the identification means, disregarding the reading error and aborting the production run. The method implements the choice of the user and adapts the course of the production run accordingly. Thus an error does not necessarily lead to an abortion of the production run, only if the user deems an abortion to be necessary.

For implementing this method in the device for making up a pharmaceutical preparation, a user interface may be provided that is linked to a processor that is adapted to read out a scanning signal provided by an RFID scanner and to determine whether the scanning signal can be read out successfully or not. The interface provides the user with an information relating to the success of the read-out and in case of a reading error provides different options to the user in between which the user may choose via the interface.

In some cases the target container in which the pharmaceutical preparation shall be provided already contains a well-defined amount of one liquid component before starting a production run. This liquid component is often a carrier solution that serves as a carrier for liquid drugs that may be added to the carrier solution during the production run. Usually the target container with such a carrier solution may take up a greater volume of liquid than the volume of the carrier solution provided with the target container. It is therefore possible to add other liquid components without exceeding an authorized volume. However, in cases in which the authorized volume would be exceeded, part of the carrier solution is first withdrawn and then the liquid component(s) is/are added. The excess volume that has to be withdrawn from the target container may be collected in a waste container.

According to an embodiment of the invention, the method may provide to weigh the waste container at least at the beginning of a production run. Additionally the weight of the waste container may be controlled every time a liquid component is injected in the waste container. Additionally, a production report may be established that comprises information relating to the amount and/or type of liquid component(s) present in the source containers, target containers and in particular also to the weight of the waste container. The weight of the waste container is an indicator for the amount of liquid component(s) present in the waste container. A weight of the waste container that is out of tolerance might be an indicator for a dosing error. This measure allows for example to detect errors due to incorrect carrier solution withdrawal and allows to reduce sources of dosing errors.

The pharmacist that decides of the pharmaceutical preparation to be composed may want to adapt the total volume of the pharmaceutical preparation in dependence of a patient for example. Sometimes only a small amount is required and the preparation of a standard volume would mainly produce waste. On the other hand a volume much greater than a standard volume may be required for the treatment of the patient. According to an embodiment of the invention, the method may provide that the user enters via a user interface one of pre-defined commands for specifying a volume relating to the pharmaceutical preparation to be made up. In order to avoid ambiguities the method may provide the possibility to a user to choose between several options, such as
a) the volume as specified by the user is the volume of the pharmaceutical preparation,
b) the volume as specified by the user is a maximum volume of the pharmaceutical preparation,
c) the volume as specified by the user is the volume of one liquid component to which another liquid component is to be added,
d) a volume range is specified by the user and the volume of the pharmaceutical preparation to be made up is within the volume range.

With option a) the method takes into account the specified volume. The volume of the pharmaceutical preparation that is made up corresponds to the volume as specified by the user. The user gets the volume of the pharmaceutical preparation as requested. If this requires to withdraw from the target container part of a carrier solution present in the target container already before starting the production run, the corresponding amount of carrier solution is withdrawn.

With option b) the user defines a maximum volume of the pharmaceutical preparation. A minimum volume is defined by other parameters resulting from the pharmaceutical preparation to be made up and the target container that is used. The maximum volume given by the user determines a minimum volume of a carrier solution present in the target container already before starting the production run that needs to be withdrawn from the target container.

With option c) the user defines the volume of one liquid component of the pharmaceutical preparation. The volumes of the other liquid components of the pharmaceutical preparation unambiguously result from the prescription comprising the chemical composition and the concentration ratios. For example the user may define a volume of a carrier solution to which one or more liquid drugs shall be added.

With option d) the user defines a volume range and the volume of the pharmaceutical preparation that is made up is within this volume range specified by the user. The volume range may have an upper limit that is 10% above a central volume value and a lower limit that is 10% below the central volume value.

The method may further provide that in case that a user does not specify a volume at all, carrier solution (if present in the target container) is not withdrawn from the target container and the required liquid component(s) is/are added as far as the authorized volume of the target container is not exceeded. If simply adding the required liquid component(s) is not possible as the authorized volume of the target container would be exceeded, the user may be requested to choose one of the options a) to d) and to indicate a volume.

For implementing this method in the device for making up a pharmaceutical preparation a user interface may be provided. The interface provides the different options to the user and the user may choose one of the options and indicate corresponding volume data via the interface.

In a further embodiment the outlet of the elastomeric pump or the outlet of a tube connected to the outlet of the elastomeric pump is equipped with a gas permeable but liquid impermeable filter. This enables flushing the outlet of the elastomeric pump or the tube connected to the outlet of the elastomeric pump in the device for making up the pharmaceutical preparation. For instance the carrier solution as such is used for flushing. Preferably the flushing occurs before injecting the liquid component into the target container. This provides an enhanced user safety for instance during the handling of a cytostatic drug as a liquid component injected into the elastomeric pump as the target container. The outlet of the elastomeric pump or the connected tube can be connected to an IV-line without exposing the user to the injected cytostatic. Since the outlet of the pump or the tube is filled with the carrier solution.

The idea underlying the invention shall subsequently be described in more detail with reference to the figures. Herein:

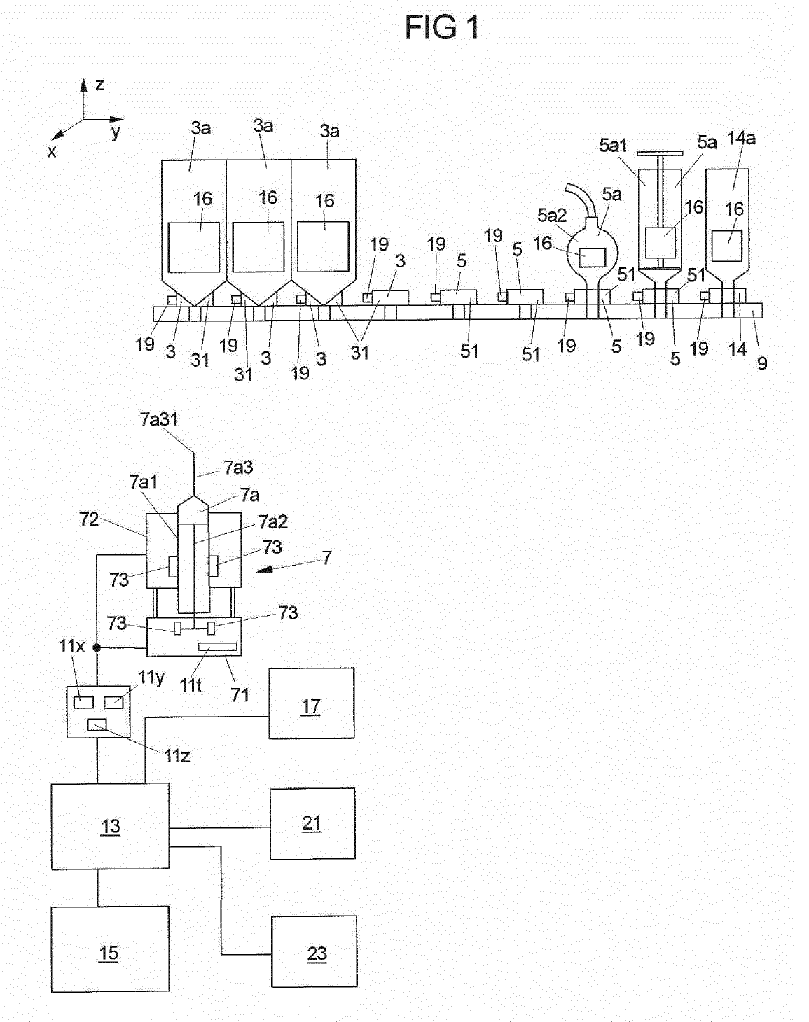

FIG. 1 schematically shows a device for making up a pharmaceutical preparation according an embodiment of the invention;

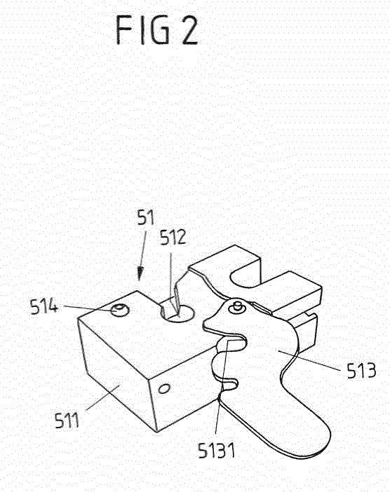

FIG. 2 schematically shows an adapter as part of a mounting device of the device of FIG. 1 adapted to hold a target container;

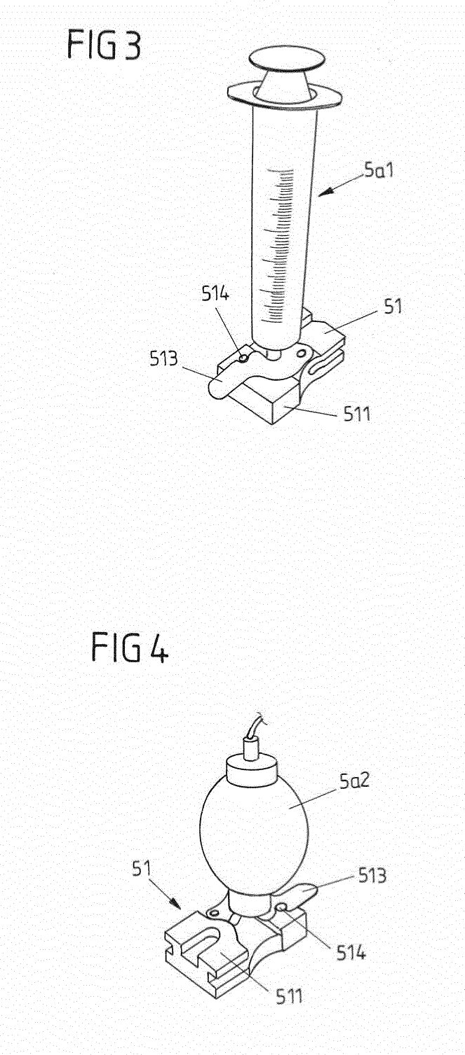

FIG. 3 schematically shows the adapter of FIG. 2 with a syringe as the target container;

FIG. 4 schematically shows the adapter of FIG. 2 with an elastomeric pump as the target container;

FIG. 5 schematically shows the syringe of FIG. 3 with an injection port;

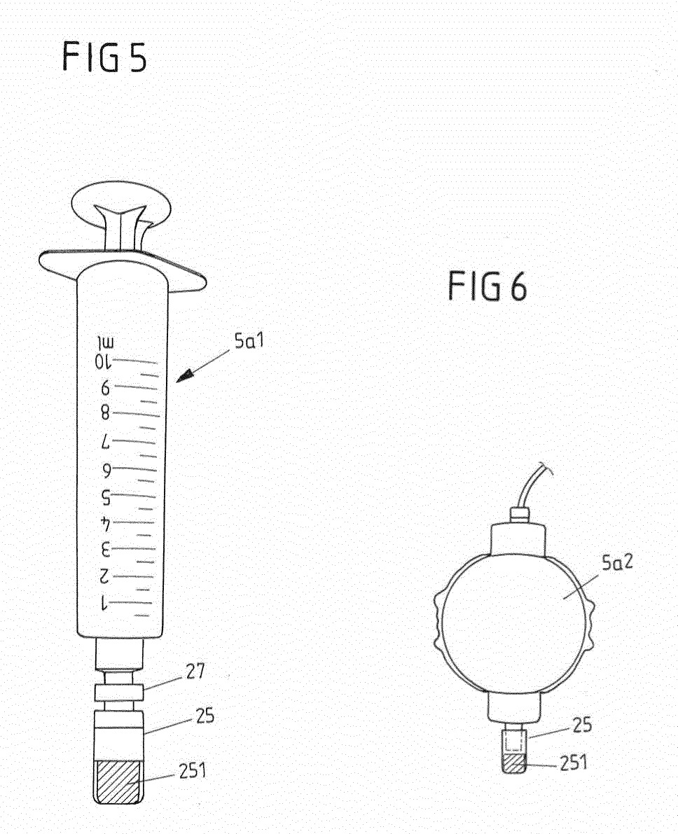

FIG. 6 schematically shows the elastomeric pump of FIG. 4 with an injection port;

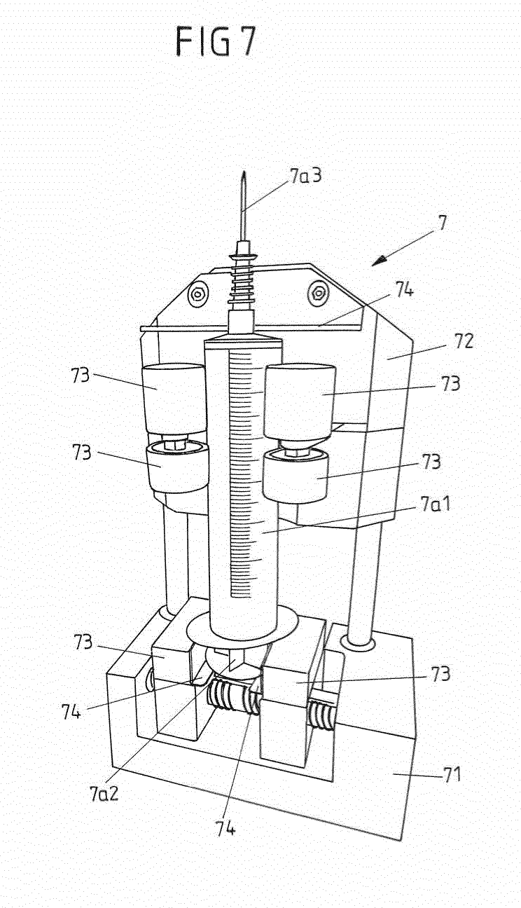

FIG. 7 schematically shows a mounting device of the device of FIG. 1 adapted to hold a transfer container;

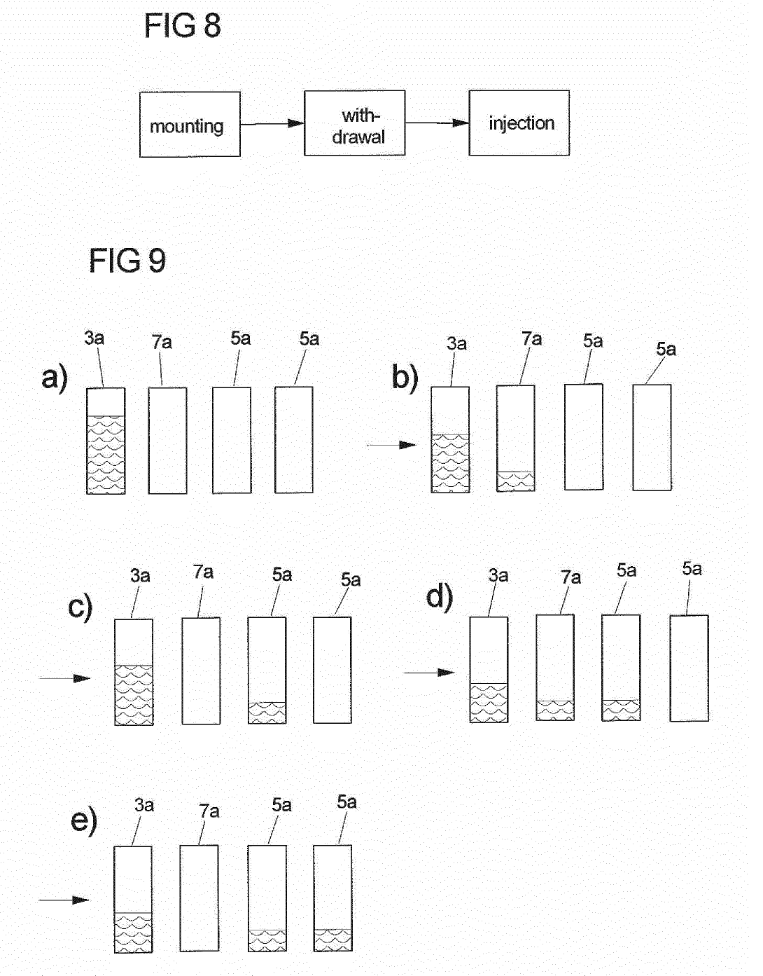

FIG. 8 schematically shows steps of a method for making up a pharmaceutical preparation;

FIG. 9 schematically shows the distribution of one liquid component of the pharmaceutical preparation among one source container, one transfer container and two target containers throughout several steps of a production run;

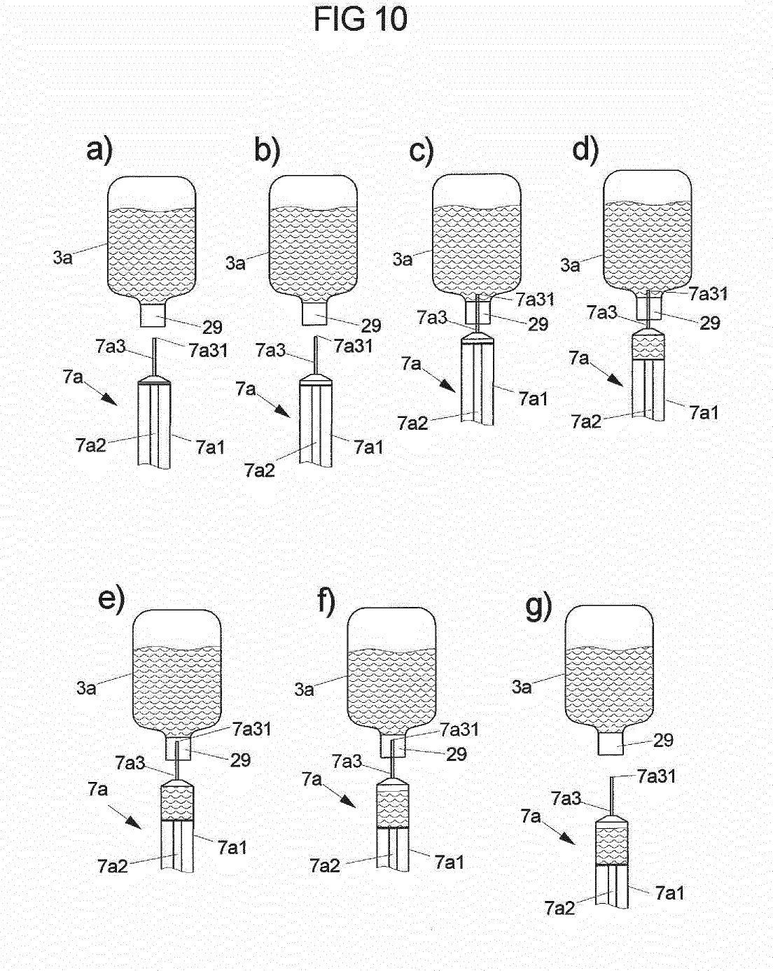

FIG. 10 schematically shows the relative position of a syringe as a transfer container and a vial as a source container and the relative position of a syringe plunger and a syringe tube throughout several steps of a production run; and

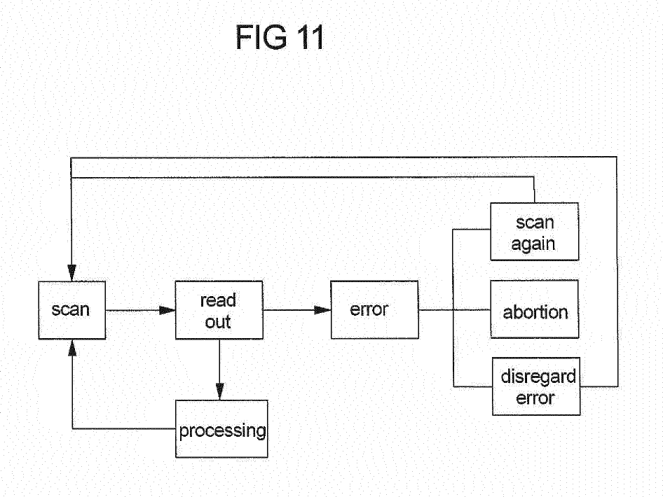

FIG. 11 shows a flow diagram of several steps related to a scan of an identification means of a source container or a target container.

FIG. 1 shows schematically a device 1 for making up a pharmaceutical preparation. The device 1 comprises a plurality of first mounting devices 3 adapted to hold a source container 3a, a plurality of second mounting devices 5 adapted to hold a target container 5a and one third mounting device 7 adapted to hold a transfer container 7a. In FIG. 1 exemplarily three first mounting devices 3 are holding a source container 3a and two second mounting devices 5 are holding a target container 5a. One first mounting device 3 adapted to hold a source container 3a and two second mounting devices 5 adapted to hold a target container 5a are free. The first mounting devices 3 and the second mounting devices 5 each comprise an adapter 31 and 51, respectively. The adapters 31 and 51 are configured to fix the source containers 3a and the target containers 5a, respectively, and are removably attached to a mounting structure 9. The adapters 31 and 51 are thus provided to securely attach the source containers 3a and the target containers 5a to the mounting structure 9. The adapters 31 and 51 may be the same or different, in dependence of the type of container 3a, 5a (vial, intravenous bag, syringe, elastomeric pump) that is used. Although in FIG. 1, only one mounting structure 9 is shown for the source containers 3a and the target containers 5a together, more than just one mounting structure 9 may be provided.

The source containers 3a are each filled with a liquid component of the pharmaceutical preparation to be made up by the device 1. The shown source containers 3a are glass vials filled with one liquid component and sealed with a puncturable septum. The target containers 5a are the containers in which the pharmaceutical preparation is to be provided. The shown target containers 5 are a syringe 5a1 and an elastomeric pump 5a2. Also an intravenous bag may be used as the target container 5a.

The third mounting device 7 adapted to hold the transfer container 7a is not attached to the mounting structure 9. The third mounting device 7 is instead movable with respect to the first mounting devices 3 and the second mounting devices 5. In order to move the third mounting device 7, three stepper motors 11x, 11y, 11z are or can be provided, one motor per axial movement along one of the axes X, Y and Z in a Cartesian coordinate system. The stepper motors 11x, 11y, 11z are of the same type, in particular of the type HECM246-F1.3. The stepper motors 11x, 11y, 11z are controlled by a processor 13.

The transfer container 7a is a syringe with a tube 7a1 and a plunger 7a2 movable in the tube 7a1 along a longitudinal axis of the syringe 7a. A needle 7a3 is attached to the tube and comprises a needle tip 7a31.

The third mounting device 7 comprises a first subunit 71 and a second subunit 72 that are movable with respect to each other. The first subunit 71 is configured to hold the plunger 7a2 of the syringe 7a and the second subunit 72 is configured to hold the tube 7a1 of the syringe 7a. For holding the tube 7a1 and the plunger 7a2 each subunit 71, 72 is provided with clamping jaws 73 that are configured to hold radially (with respect to the longitudinal axis of the syringe 7a) the tube 7a1 and the plunger 7a2. The third mounting device 7 also comprises stop elements 74 that will be described later with reference to FIG. 7.

In order to move the first subunit 71 with respect to the second subunit 72 a stepper motor 11t is provided. The stepper motor 11t may be of the same type as the stepper motors 11x, 11y, 11z provided to move the third mounting device 7 with respect to the first mounting devices 3 and the second mounting devices 5. If the syringe 7a is arranged at the third mounting device 7 as intended the movement of the first subunit 71 with respect to the second subunit 72 makes the plunger 7a2 move in and/or out of the tube 7a1.

The device 1 further comprises a fourth mounting device 14 adapted to hold a waste container 14a. The waste container 14a is for instance used to discharge an excess of a liquid component present in (one of) the target containers 5a before starting a production run. Often the target containers 5a that are used are prefilled with a defined amount of a so-called carrier solution as one liquid component of the pharmaceutical preparation. The carrier solution serves as a carrier for a liquid component (liquid drug) that is provided in one of the source containers 3a and that is added to the carrier solution in the target container 5a. In case that the amount of the liquid component to be added and the defined amount of the carrier solution exceed the volume that can be taken up by the target container 5a, a part of the carrier solution is withdrawn from the target container 5a and injected into the waste container 14a by means of the transfer container 7a. The waste container 14a comprises an access port that is sealed with a puncturable septum. The waste container 14a may be a glass or plastic vial or an intravenous bag. The fourth mounting device 14 comprises an adapter that is configured to fix the waste container 14a and that is removably attached to the mounting structure 9.

The device 1 further comprises a camera 15 adapted to capture an image of the source containers 3a and/or of the target containers 5a. The image comprises image data representative of the liquid component filled in the different source containers 3a and the pharmaceutical preparation to be made up in the different target containers 5a. For this purpose each source container 3a and each target container 5a is provided with an (adhesive) label 16 that comprises the information representative of the liquid component filled in the source container 3a and the pharmaceutical preparation to be made up in the target container 5a. The information is provided in form of a graphic representation adapted to be captured by the camera 15. The camera 15 is configured to send the image data to the processor 13 which in turn is configured to receive the image data from the camera 15 and to identify the liquid component filled in the source containers 3a and/or the pharmaceutical preparation to be made up in the target containers 5a by means of image recognition. Also the waste container 14a is provided with a label 16 indicating that the waste container 14a is intended to receive waste.

Additionally, the device 1 comprises an RFID (radio-frequency identification) scanner 17. The RFID scanner 17 is adapted to scan RFID tags 19 that are attached as an identification means to the source containers 3a and to the target containers 5a. The RFID scanner 17 is also adapted to send a corresponding signal to the processor 13. In the embodiment of FIG. 1 the RFID tags 19 are arranged on the adapters 31 and 51 of the source containers 3a and of the target containers 5a, respectively. By fixing the source containers 3a and the target containers 5a to the respective adapters 31, 51, the source containers 3a and the target containers 5a are simultaneously tagged with an RFID tag 19. Also the adapter of the waste container 14a comprises a RFID tag 19.

The camera 15 and the RFID scanner 17 are both connected to the processor 13. The camera 15, the labels 16, the RFID scanner 17 and the RFID tags 19 are used to assign features like a position on the mounting structure 9 (or with respect to another reference) and/or a weight to one specific container 3a, 5a and its content. Such an assignment is required to automate the method for making up a pharmaceutical preparation executed by the device 1. In particular, a correlation between image data provided by the camera 15 and signals of the RFID scanner 17 are correlated for the same container 3a, 5a by means of the processor 13. These means (the camera 15, the labels 16, the RFID scanner 17 and the RFID tags 19) are also used to track the status of the production run and of the different containers 3a, 5a used in the production run as well as to control the correct execution of the method by the device 1.

An interface 21, in particular a graphical user interface, is provided to the user in order to interact with the device 1. The interface 21 communicates with the processor 13.

Furthermore, the device 1 comprises a balance 23. The balance 23 serves to determine the weight of the source containers 3a, the target containers 5a and the waste container 14a at least at the beginning of a production run. As a control measure for controlling the correct dosing, the weight of the source containers 3a, the target containers 5a and the waste container 14a may be determined during the production run as well.

FIG. 2 shows in detail the adapter 51 of the second mounting device 5 adapted to hold a target container 5a. The adapter 51 is configured and designed such as to hold in particular a syringe or an elastomeric pump as the target container 5a. However, also an intravenous bag may be hold by the adapter 51 shown in FIG. 2.

The adapter 51 comprises a body 511 made of a plastic material. A through hole 512 traverses the body 511. The through hole 512 is adapted to loosely receive an access port of the target container 5a. A bracket 513 is pivotably attached to the body 511 such that the bracket 513 is movable between a locking position, wherein the target container 5a is securely fixed to the adapter 51, and a release position, wherein the target container 5a is separable from the adapter 51.

The bracket 513 comprises a recess 5131 for receiving the access port of the target container 5a. In the locking position, the access port is securely held in the recess 5131 by form fitting. The bracket 513 is made of a metal.

In order to avoid that the bracket 513 is moved (coming from the release position) beyond the locking position, a stop element 514 is provided on the body 511, against which the bracket 513 abuts when the bracket 513 has reached the locking position. The stop element 514 avoids on the one hand that the access port of the target container 5a is damaged by moving the bracket 513 beyond the locking position and indicates on the other hand to a user that the locking position has been reached and that the target container 5a is securely fixed to the adapter 51.

In FIG. 2 the bracket 513 is shown in the release position. In the release position the bracket 513, and in particular the recess 5131, is spaced apart from the through hole 512. In the locking position (FIGS. 3 and 4) the recess 5131 of the bracket 513 is in line with the through hole 512.

FIG. 3 shows a syringe 5a1 as the target container 5a securely hold by the adapter 51. The syringe 5a1 of FIG. 3 without the adapter 51 is shown in FIG. 5. The syringe 5a1 has an access port that is not provided with a needle but with an injection port 25 that is connected to the syringe for instance via a female-female connector 27. The injection port 25 comprises a septum 251 that is puncturable by the needle 7a3 of the syringe 7a as the transfer container.

FIG. 4 shows an elastomeric pump 5a2 as the target container 5a securely hold by the adapter 51. The elastomeric pump 5a2 of FIG. 4 without the adapter 51 is shown in FIG. 6. Also the elastomeric pump 5a2 is provided with an injection port 25 with a puncturable septum 251.

FIG. 7 shows the third mounting device 7 for holding a syringe 7a as the transfer container in detail. The two clamping jaws 73 of the first subunit 71 are arranged on opposite sides of the longitudinal axis of the syringe 7a if the syringe 7a is arranged at the third mounting device 7 as intended. At least one of the clamping jaws 73 is motor-driven in order to be movable (along an axis that is perpendicular to the longitudinal axis of the syringe 7a) with respect to the other clamping jaw 73 such that the plunger 7a2 is radially clamped between the two clamping jaws 73. A stop element 74 protrudes from each clamping jaw 73 in a plane perpendicular to the longitudinal axis of the syringe 7a, if the syringe 7a is arranged at the third mounting device 7 as intended. The stop elements 74 are oriented from the clamping jaws 73 towards the longitudinal axis of the syringe 7a.

If the syringe 7a is arranged at the third mounting device 7 as intended, the plunger 7a2 (with its free end) abuts against the stop elements 74. According to an alternative, the stop elements 74 comprise a notch to receive the free end of the plunger 7a2 such that the free end of the plunger 7a2 is blocked along the longitudinal axis of the syringe 7a in both directions. According to another alternative, the first subunit 71 may comprise another stop element that is axially displaced from the stop elements 74 of the first subunit 71 shown in FIG. 7. This other stop element 74 is arranged such that the free end of the plunger 7a2 is axially (with respect to the longitudinal axis of the syringe) hold in between the stop elements, preventing the plunger 7a2 from moving with respect to the clamping jaws 73 of the first subunit 71.

The second subunit 72 comprises a stop element 74 that extends in a plane perpendicular to the longitudinal axis of the syringe 7a if the syringe 7a is arranged at the third mounting device 7 as intended. The stop element 74 is arranged such that the tube 7a1 axially abuts against the stop element 74 preventing the tube 7a1 from moving forward when the plunger 7a2 is pushed into the tube 7a1. According to an alternative, the second subunit 72 may comprise another stop element that extends in a plane perpendicular to the longitudinal axis of the syringe 7a if the syringe 7a is arranged at the third mounting device 7 as intended and that is axially displaced from the stop element 74 shown in FIG. 7. This other stop element 74 is arranged such that the tube 7a1 on its opposite side axially abuts against the stop element preventing the tube 7a1 from moving backward when the plunger 7a2 is pulled out of the tube 7a1.

The clamping jaws 73 of the second subunit 72 are cylindrical rollers arranged on opposite sides of the longitudinal axis of the syringe 7a if the syringe 7a is arranged at the third mounting device 7 as intended. The axis of rotation of the cylindrical rollers are substantially parallel to the longitudinal axis of the syringe 7a. The cylindrical rollers are arranged at a distance to each other that allows them to clamp the tube 7a1 of the syringe 7a in between them. Additionally the cylindrical rollers are provided with a rubbery surface in order to increase the friction between the tube surface and the surface of the cylindrical rollers. Additionally or alternatively, the cylindrical rollers may be pre-tensioned against each other such as to apply an additional, radially oriented force to the tube 7a1.

FIG. 8 shows the principle steps “mounting”, “withdrawal” and “injection” of a method of making up a pharmaceutical preparation. The method is implemented by using the device 1 for making up a pharmaceutical preparation shown in FIG. 1. The step “mounting” comprises mounting on respective first, second and third mounting devices 3, 5, 7 one or more source container(s) 3a (each) filled with a liquid component of the pharmaceutical preparation, a target container 5a for receiving the liquid component(s) from the source container(s) 3a and a transfer container 7a adapted to transfer the liquid component(s) from the source container(s) 3a to the target container 5a. The step “withdrawal” comprises withdrawing the liquid component from the source container 3a using the transfer container 7a, wherein the third mounting device 7 is in a withdrawal position. The step “injection” comprises injecting the liquid component withdrawn from the source container 3a into the target container 5a using the transfer container 7a.

In case that more than one source container 3a is provided and that the pharmaceutical preparation is to be made up of a plurality of liquid components that are present in the provided source containers 3a, the steps “withdrawal” and “injection” are iteratively repeated. For the transfer of each liquid component a separate transfer container 7a is used in one embodiment. It is also possible that the target container 5a is provided already comprising a carrier solution to which one (or more) liquid component(s) from the source container(s) 3a has/have to be added.

It may also happen that a user wants to prepare a plurality of target containers 5a with the same or different pharmaceutical preparations in one production run of the device 1. The method according to the invention provides a sequence of steps that will be described with reference to FIG. 9. Exemplarily two target containers 5a are provided that are each prefilled with a carrier solution. To each target container 5a the same liquid component present in one source container 3a needs to be added. The same or two separate transfer containers 7a can be used. In the example shown in FIG. 9 only one transfer container 7a is used. FIG. 9 schematically shows the distribution of the relevant liquid component of the pharmaceutical preparation (that is to be added to the carrier solution) among one source container 3a, one transfer container 7a and two target containers 5a. For the sake of clarity the carrier solution is not shown.

In the initial situation a) the liquid component is present only in the source container 3a. In the subsequent situation b) a predefined amount of the liquid component has been withdrawn from the source container 3a into the transfer container 7a, so that the liquid component is present in the source container 3a and the transfer container 7a. In the subsequent situation c) the liquid component has been injected in one of the target containers 5a from the transfer container 7a. The liquid component is present in the source container 3a and the one target container 5a. In the subsequent situation d) again a predefined amount of the liquid component has been withdrawn from the source container 3a into the transfer container 7a, so that the liquid component is present in the source container 3a, the one target container 5a and the transfer container 7a. In the subsequent situation e) the liquid component has been injected in the other one of the target containers 5a from the transfer container 7a. The liquid component is present in the source container 3a and the two target containers 5a. The procedure shown in FIG. 9 is in particular adapted if the target containers 5a are elastomeric pumps and syringes.

In case that a syringe is used as the transfer container 7a the method provides several particularities aiming at increasing the dosing precision on the one hand and at preventing contamination of the surrounding environment with the liquid components on the other hand. FIG. 10 shows the relative position of the syringe 7a as the transfer container and a vial as the source container 3a and the relative position of the syringe plunger 7a2 and the syringe tube 7a1 throughout several steps of the method. The relative position of the syringe 7a and the vial 3a and the relative position of the syringe tube 7a1 and the syringe plunger 7a2 change throughout the steps. The changes result from a movement of the third mounting device 7 relative to the first mounting device 3 and from a movement of the first subunit 71 of the third mounting device 7 relative to its second subunit 72, respectively. The vial 3a comprises an access port that is sealed with a septum 29 that is puncturable by the needle 7a3 of the syringe 7a. Means for venting the vial 3a are not illustrated in the figures. Instead of the vial other source containers 3a sealed with a septum may be used.

In the initial situation a) the syringe 7a, and in particular the needle 7a3 with its tip 7a31, is spaced apart from the vial 3a. In the subsequent step b) the plunger 7a2 has been slightly pulled out of the tube 7a1 such that a defined volume of air is sucked in the syringe 7a. As the material of the plunger 7a2 is somewhat flexible, this movement of the plunger 7a2 out of the tube 7a1 changes the shape of the plunger 7a2. When subsequently the liquid component is withdrawn from the vial 3a, the plunger has adopted this deformed shape already before starting the withdrawal. The shape change thus does not occur during the withdrawal of the liquid component avoiding that the dosing accuracy is adversely affected.

In the subsequent step c) the needle 7a3 punctures the septum 29 of the vial 3a and the syringe 7a is positioned in a predefined withdrawal position relative to the vial 3a. The withdrawal position, in particular the insertion depth of the needle 7a3 into the vial 3a, depends on the type, shape and size of the source container 3a. The withdrawal position is chosen such that the vial 3a can be optimally emptied and the residual amount of the liquid component that cannot be withdrawn from the vial 3a is as small as possible. In the subsequent step d) the withdrawal position is maintained and a predefined amount of the liquid component is withdrawn from the vial 3a.

In the subsequent step e) the syringe 7a is slightly, but not completely, pulled out of the vial 3a. The syringe 7a adopts a position relative to the vial 3a wherein the needle tip 7a31 is located inside the septum 29. In this so-called contamination prevention position the needle tip 7a31 neither contacts the liquid component in the vial 3a nor the air surrounding the vial 3a and the syringe 7a. The contamination prevention position depends on the type, shape and size of the source container 3a. In the subsequent step f) the contamination prevention position is maintained and the plunger 7a2 is slightly pulled out of the tube 7a1. As the needle tip 7a31 is sealed by the septum 29 neither air nor the liquid component can be sucked into the syringe 7a leading to an underpressure in the syringe 7a. By creating the underpressure residual droplets of the liquid component inside the needle 7a3 and/or at the needle tip 7a31 are sucked into the syringe 7a and may not contaminate the environment when pulling the needle 7a3 completely out of the septum 29 in the subsequent step g).

As shown in FIG. 1 the source containers 3a and the target containers 5a are provided with RFID tags 19 for tracking the status of these containers throughout a production run. With an RFID scanner 17 the RFID tags 19 are regularly scanned. FIG. 11 shows a flow diagram related to the scanning of the RFID tags 19. According to FIG. 11 the RFID tag 19 is first scanned by the RFID scanner 17. The RFID scanner 17 provides a scanning signal that is read out by the processor 13 already described with reference to FIG. 1. As a result, the scan may be successfully read out. In this case a further scanning step follows after a predetermined amount of time has lapsed. In case that the scanning signal cannot be read out successfully, different options are presented to the user via the interface 21. The first option is to scan again the RFID tag 19. If this option is selected by the user, the RFID tag 19 is immediately scanned again by the RFID scanner 17 without awaiting the next regular scanning step. The second option is to abort the production run. If this option is selected by the user, the entire production run is immediately aborted. The third option is to disregard the reading error. If this option is selected by the user, the procedure continues as if the scanning signal has been read out successfully and a further scanning step follows after a predetermined amount of time has lapsed.

1. A device for making up a pharmaceutical preparation comprising
a) at least one first mounting device adapted to hold a source container filled with a liquid component of the pharmaceutical preparation,
b) at least one second mounting device adapted to hold a target container provided with at least one access port for receiving the liquid component of the pharmaceutical preparation, and
c) at least one third mounting device adapted to hold a transfer container adapted to transfer the liquid component from the source container to the target container,
wherein the at least one third mounting device is movable with respect to the at least one first mounting device and to the at least one second mounting device such that the liquid component can be transferred from the source container to the target container.

2. The device according to claim 1, wherein the second mounting device comprises an adapter adapted to hold a syringe or an elastomeric pump as the target container.

3. The device according to claim 1, wherein the adapter comprises a through hole for loosely receiving the access port of the target container.

4. according to claim 2, wherein the adapter comprises a bracket movable between a locking position, wherein the target container is securely fixed to the adapter), and a release position, wherein the target container (5a) is separable from the adapter.

5. The device according to claim 1, wherein the target container comprises a syringe or an elastomeric pump, wherein the access port of the syringe or the elastomeric pump comprises an injection port with a septum that is puncturable in order to inject the liquid component into the syringe or the elastomeric pump.

6. The device according to claim 5, wherein the injection port is removably attached to the access port of the syringe or the elastomeric pump.

7. The device according to claim 1, wherein the third mounting device comprises at least one stop element for limiting a movement of the transfer container in a direction towards the at least one first mounting device and/or towards the at least one second mounting device.

8. The device according to claim 7, wherein the at least one third mounting device comprises two stop elements, arranged such as to receive the transfer container in between them and as to limit a movement of the transfer container in a direction towards the at least one first mounting device and/or towards the at least one second mounting device and a movement of the transfer container in a direction away from the at least one first mounting device and from the at least one second mounting device.

9. The device according to claim 1, wherein the at least one third mounting device is adapted to hold a syringe with a tube and a plunger movable inside the tube.

10. The device according to claim 8, wherein the at least one third mounting device comprises a first subunit and a second subunit that are movable with respect to each other, wherein each of the subunits is provided with one of the stop elements and wherein the first subunit is adapted to hold the plunger of the syringe and the second subunit is adapted to hold the tube of the syringe.

11. The device according to claim 1, further comprising by a stepper motor, configured to move the at least one third mounting device with respect to the at least one first mounting device and to the at least one second mounting device.

12. The device according to claim 1, further comprising a camera adapted to capture an image of the source container and/or of the target container, wherein the image comprises image data representative of the liquid component filled in the source container and/or the pharmaceutical preparation to be made up in the target container.

13. The device according to claim 12, further comprising a processor adapted to receive the image data from the camera and to identify the liquid component filled in the source container and/or the pharmaceutical preparation to be made up in the target container by means of image recognition.

14. A method for making up a pharmaceutical preparation comprising:
a) mounting a source container filled with a liquid component of the pharmaceutical preparation on a first mounting device,
b) mounting a target container provided with at least one access port for receiving the liquid component on a second mounting device,
c) mounting a transfer container adapted to transfer the liquid component from the source container to the target container on a third mounting device,
d) withdrawing the liquid component from the source container using the transfer container, while the third mounting device is in a withdrawal position, and
e) injecting the liquid component into the target container using the transfer container, wherein the transfer container for the injection is brought into an injection position by moving the third mounting device.

15. The method according to claim 14, wherein filling a plurality of target containers with the liquid component is achieved by repeating steps d) and e) for each of the target containers.

16. The method according to claim 14, wherein a speed for withdrawing the liquid component from the source container and a speed for injecting the liquid component into the target container is set in dependence of the liquid component, including in dependence of the viscosity of the liquid component.

17. The method according to claim 14, wherein before withdrawing the liquid component from the source container:
a) the third mounting device is moved along an X-axis and/or along a Y-axis and/or along a Z-axis, wherein the movement along the X-axis and the Y-axis is permitted only as long as a distance between the third mounting device and the first mounting device along a Z-axis does not fall below a predefined threshold value,
b) once the third mounting device has reached a position along the X-axis and the Y-axis corresponding to the withdrawal position, the third mounting device moves along the Z-axis and reduces its distance to the first mounting device along the Z-axis until the withdrawal position is reached.

18. The method according to claim 17, wherein the withdrawal position along the Z-axis is set depending on the type of the source container.

19. The method according to claim 14, wherein a syringe comprising a needle with a needle tip (7a31) is used as the transfer container, wherein the source container comprises an injection port which is puncturable by the needle.

20. The method according to claim 19, wherein the step of withdrawing the liquid component from the source container comprises: before puncturing the injection port of the source container with the needle tip, sucking a predefined volume of air into the syringe.

21. The method according to claim 19, further comprising the steps of:
a) after withdrawing the liquid component from the source container, moving the syringe away from the source container into a contamination prevention position in which the needle tip is placed within the injection port of the source container, wherein the contamination prevention position is set depending on the type of the source container,
b) while the syringe is in the contamination prevention position, creating an underpressure in the syringe, and
c) pulling the needle out of the injection port.

22. The method according to claim 14, wherein the status of the source container and the target container is tracked throughout a production run, including at the beginning and/or end of each step of withdrawal of the liquid component from the source container and at the beginning and/or end of each step of injection of the liquid component into the target container, in order to register a change of the status.

23. The method according to claim 22, wherein the source container and the target container each are provided with an identification means, wherein the identification means includes an individual RFID tag, and wherein the identification means is scanned regularly in order to track the status of the source container and of the target container.

24. The method according to claim 23, wherein in case of an error related to the scanning of the identification means, an interface is provided that allows a user to choose between:
a) scanning again the identification means,
b) disregarding the error and continuing the production run, and
c) aborting the production run,
wherein the method is adapted according to the choice of the user.

25. The method according to claim 14, wherein prior to step e) or step d), an amount of a liquid component present in the target container is withdrawn from the target container and injected into a waste container.

26. The method according to claim 25, wherein a production report is established for each production run, wherein the production report comprises information relating to the amount and/or type of liquid component present in the source container, the target container and the waste container.

27. The method according to claim 14, wherein the user enters a pre-defined command for specifying a volume relating to the pharmaceutical preparation to be made up.

28. The method according to claim 27, wherein in dependence of the command entered by the user:
a) the volume of the pharmaceutical preparation that is made up corresponds to the volume as specified by the user,
b) the volume of the pharmaceutical preparation that is made up is smaller than or equal to a maximum volume as specified by the user,
c) the volume of one liquid component of the pharmaceutical preparation that is made up corresponds to the volume as specified by the user, or
d) the volume of the pharmaceutical preparation that is made up is within a volume range specified by the user.

29. The method according to claim 14, further comprising equipping an outlet of the elastomeric pump and/or an outlet of a tube connected to the outlet of the elastomeric pump with a gas permeable but liquid impermeable filter, and flushing the outlet of the elastomeric pump or the tube connected to the outlet of the elastomeric pump.
